(19) United States
(12) Patent Application Publication
(10) Pub. No.: US 2025/0290496 A1
(43) Pub. Date: Sep. 18, 2025

(54) INFLATION PUMP AND INFLATION DEVICE

(71) Applicant: DONGGUAN HANG CHE BAO FUTURE TECHNOLOGY CO., LTD., Dongguan (CN)

(72) Inventor: Guofa ZENG, Dongguan (CN)

(73) Assignee: DONGGUAN HANG CHE BAO FUTURE TECHNOLOGY CO., LTD., Dongguan (CN)

(21) Appl. No.: 18/925,441

(22) Filed: Oct. 24, 2024

Related U.S. Application Data
(63) Continuation of application No. PCT/CN2024/120515, filed on Sep. 24, 2024.

(30) Foreign Application Priority Data
Mar. 13, 2024 (CN) 202420491464.6

(51) Int. Cl. F04B 17/03; F02N 11/00; F04B 53/10

(52) U.S. Cl. CPC F04B 17/03; F02N 11/003; F04B 53/10

(57) ABSTRACT

Disclosed are an inflation pump and an inflation device. The inflation pump includes a first mounting part, a first inflation apparatus and a second inflation apparatus. The first mounting part is used for connecting an apparatus to be inflated. The first inflation apparatus includes a first driving assembly and a first inflation assembly. The first driving assembly is used for supplying power to the first inflation assembly, and the first inflation assembly provides a first air flow to the first mounting part to inflate the apparatus to be inflated. The second inflation apparatus includes a second driving assembly and a second inflation assembly, the second driving assembly is used for supplying power to the second inflation assembly, and the second inflation assembly is connected to the first inflation assembly and provides a second air flow to the first mounting part to inflate the apparatus to be inflated.

### CROSS-REFERENCE TO RELATED APPLICATIONS

The present application is a continuation of International Application No. PCT/CN2024/120515, filed on Sep. 24, 2024, which claims priority to Chinese Patent Application No. 202420491464.6, filed on Mar. 11, 2024. The disclosures of the aforementioned applications are hereby incorporated by reference in their entireties.

### TECHNICAL FIELD

The present application relates to the field of inflation apparatus technologies, and in particular, to an inflation pump and an inflation device.

### BACKGROUND

An inflation pump, also called as inflation machine, air pump, or inflator, operates by rotation of a motor and is an inflation tool. A working principle of the inflation pump is as follows: when the motor operates to draw air, a valve of a connector is opened by atmospheric pressure, and the air enters a cylinder; and when air is pumped into an apparatus to be inflated, the valve is closed by a pressure of gas in the cylinder and the air enters the apparatus to be inflated. The inflation pump is widely used in application fields related to vehicles, motorcycles, bicycles, balls, paddle blades, rubber boats, and the like. At present, most of the inflation pumps on the market generally have a single cylinder structure, resulting in technical problems of insufficient gas pressure, long inflation time, and difficulty in inflating devices with a relatively large size.

### SUMMARY

In view of this, in order to overcome defects in conventional technologies, the present application provides an inflation pump to solve technical problems that an inflation pump in the conventional technologies is mostly a single-cylinder structure, resulting in insufficient gas pressure, long inflation time, and difficulty in inflating devices with a relatively large size.

In order to solve the above-mentioned technical problems, in a first aspect, the present application provides an inflation pump, the inflation pump include:
a first mounting part, for connecting an apparatus to be inflated;
a first inflation apparatus, where the first inflation apparatus includes a first driving assembly and a first inflation assembly, the first driving assembly is configured to supply power to the first inflation assembly, and the first inflation assembly is configured to provide a first air flow to the first mounting part to inflate the apparatus to be inflated; and
a second inflation apparatus, where the second inflation apparatus includes a second driving assembly and a second inflation assembly, the second driving assembly is configured to supply power to the second inflation assembly, and the second inflation assembly is connected to the first inflation assembly and is configured to provide a second air flow to the first mounting part to inflate the apparatus to be inflated.

In addition, the inflation pump provided in the first aspect of the present application may further be in combination with any of the following possible embodiments.

In some embodiments of the present application, the inflation pump further includes a gas pipe including a second mounting part and a third mounting part. The first mounting part is provided on the gas pipe, the first inflation assembly is connected to the second mounting part, and the second inflation assembly is connected to the third mounting part.

In some embodiments of the present application, the second mounting part and the first mounting part are coaxially arranged.

In some embodiments of the present application, the second mounting part and the third mounting part are coaxially arranged.

In some embodiments of the present application, in a unit time, a volume of gas provided by the first inflation apparatus to the first mounting part is less than a volume of gas provided by the second inflation apparatus to the first mounting part.

In some embodiments of the present application, a gas pressure of gas provided by the first inflation apparatus to the first mounting part is higher than a gas pressure of gas provided by the second inflation apparatus to the first mounting part.

In some embodiments of the present application, the inflation pump further includes a gas pressure detection apparatus and a fourth mounting part. The fourth mounting part is provided at the inflation pump close to the first mounting part, and the gas pressure detection apparatus is provided at the fourth mounting part and is configured to detect a gas pressure of the apparatus to be inflated.

In some embodiments of the present application, the gas pressure detection apparatus includes a pressure sensor.

In some embodiments of the present application, a first check valve for unidirectionally passing through the first air flow is provided between the first inflation assembly and the second mounting part.

In some embodiments of the present application, the first check valve is provided on the first inflation assembly.

In some embodiments of the present application, the first inflation assembly includes a first cylinder having a first surface, a fifth mounting part for mounting the first check valve is provided at a center of the first surface, and the first surface is provided with a plurality of first vent holes.

In some embodiments of the present application, the first inflation assembly includes a first cylinder having a first through hole, and a sixth mounting part for mounting the first check valve is provided close to the second mounting part, in the first through hole.

In some embodiments of the present application, the first check valve is provided on the gas pipe.

In some embodiments of the present application, the gas pipe has a second surface, where a seventh mounting part for mounting the first check valve is provided at a center of the second surface, and the second surface is provided with a plurality of second vent holes.

In some embodiments of the present application, an eighth mounting part for mounting the first check valve is provided close to the first inflation assembly, on an inner wall of the gas pipe.

In some embodiments of the present application, a second check valve for unidirectionally passing through the second air flow is provided between the second inflation assembly and the third mounting part.

In some embodiments of the present application, a third check valve, for unidirectionally passing through the first air flow or the second air flow to inflate the apparatus to be inflated, is provided at the first mounting part of the inflation pump.

In some embodiments of the present application, the first driving assembly includes a first motor electrically connected with a capacitor.

In some embodiments of the present application, the first driving assembly includes a first motor and a first support for mounting the first motor, and the first inflation assembly includes a first cylinder connected to the first support.

In some embodiments of the present application, the first inflation assembly includes a first cylinder and a first gas outlet pipe disposed on the first cylinder, the first mounting part is provided on the first gas outlet pipe, and the first gas outlet pipe is connected to the second inflation assembly.

In some embodiments of the present application, the second inflation assembly includes a blower housing and a second gas outlet pipe disposed on the blower housing, the first mounting part is provided on the second gas outlet pipe, and the second gas outlet pipe is connected to the first inflation assembly.

In some embodiments of the present application, the second inflation assembly includes a blower housing, a ninth mounting part, for gas intake or connection with an apparatus to be deflated, is provided at an end of the blower housing away from the first mounting part.

In some embodiments of the present application, the second inflation assembly further includes a blower support provided in the blower housing, and a protection member for filtering gas from the ninth mounting part is provided between the blower housing and an end of the blower support close to the ninth mounting part.

In some embodiments of the present application, at least one second through hole is provided at an end of the blower housing away from the first mounting part, for preventing the blower from damage due to overheating.

In a second aspect, in the embodiments of the present application, an inflation device is further provided, including:
the inflation pump in any embodiment as described above;
a controller, electrically connected to the first driving assembly and the second driving assembly;
a power source for supplying power, electrically connected to the controller and the inflation pump; and
an outer housing in which the inflation pump, the controller and the power source are provided.

In some embodiments of the present application, the inflation apparatus further includes a third inflation apparatus provided in the outer housing. The third inflation apparatus include a third driving assembly and a third inflation assembly, the third driving assembly is connected to the third inflation assembly and is used for supplying power to the third inflation assembly, and an end of the third inflation assembly away from the third driving assembly is used for connecting an apparatus to be inflated. The third driving assembly is electrically connected to the power source and the controller.

In some embodiments of the present application, a gas pressure of gas provided by the third inflation apparatus to the apparatus to be inflated is higher than a gas pressure of gas provided by the first inflation apparatus to the apparatus to be inflated.

In some embodiments of the present application, in a unit time, a volume of gas provided by the third inflation apparatus to the apparatus to be inflated is less than a volume of gas provided by the second inflation apparatus to the apparatus to be inflated.

In some embodiments of the present application, the inflation apparatus further includes a pair of output terminals, and the output terminals are electrically connected with the power source and are used for outputting a current for starting an engine of a vehicle.

In some embodiments of the present application, the inflation apparatus further includes at least one output port, and the output port is electrically connected to the power source and is used for supplying power to an external apparatus.

Compared with the conventional art, the beneficial effects of the present application are as follows.

In the present application, the inflation pump is provided, and the inflation pump includes the first mounting part, the first inflation apparatus and the second inflation apparatus. The first inflation apparatus includes a first driving assembly and a first inflation assembly, and the second inflation apparatus includes a second driving assembly and a second inflation assembly. By providing the first driving assembly for supplying power to the first inflation assembly, the first inflation assembly is driven by the first driving assembly to provide the first air flow to the first mounting part to make the first mounting part inflate the apparatus to be inflated. By providing the second driving assembly for supplying power to the second inflation assembly which is connected to the first inflation assembly, the second inflation assembly is driven by the second driving assembly to provide the second air flow to the first mounting part, to make the first mounting part inflate the apparatus to be inflated. Compared with the inflation pump having the single cylinder structure in the conventional art, the inflation efficiency is effectively improved, the inflation time is shortened, and it is suitable for inflation of apparatuses with a relatively large size.

### BRIEF DESCRIPTION OF THE DRAWINGS

In order to explain technical solutions of the embodiments of the present application more clearly, the drawings required to be used in the embodiments will be briefly introduced as below. It should be understandable that the drawings merely illustrate some embodiments of the present application, and thus should not be considered as limitations to the scope. For a person skilled in the art, other related drawings may be obtained according to these drawings without any inventive work.

FIG. 1 shows a three-dimensional schematic (3D) diagram of an inflation pump in some embodiments of the present application.

FIG. 2 shows a section view of an inflation pump in some embodiments of the present application.

FIG. 3 shows a first exploded schematic diagram of an inflation pump in some embodiments of the present application.

FIG. 4 shows a section view of FIG. 3.

FIG. 5 shows a second exploded schematic diagram of an inflation pump in some embodiments of the present application.

FIG. 6 shows a third exploded schematic diagram of an inflation pump in some embodiments of the present application.

FIG. 7 shows a first 3D diagram of an inflation device in some embodiments of the present application.

FIG. 8 shows a second 3D diagram of an inflation device in some embodiments of the present application.

FIG. 9 shows a bottom view of an inflation device in some embodiments of the present application.

### DETAILED DESCRIPTION OF THE EMBODIMENTS

Hereinafter, embodiments of the present application will be explained in detail. Examples of the embodiments will be illustrated in the drawings where the same or similar reference symbols are used to indicate the same or similar elements or indicate elements having the same or similar functions throughout the specification. The embodiments to be described below referring to the figures are exemplary, and merely for explanation to the present application, rather than limitations to the present application.

In the description of the present application, it should be understood that the orientations or position relations as indicated by the terms of “center”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “anticlockwise”, “axial”, “radial”, “circumferential”, and the like are the orientations or the position relations as shown based on the drawings, they are used merely to facilitate description of the present application and to simplify the description, rather than indicating or implying that the mentioned apparatus or element must be arranged in a specific orientation or position, or be configured or operated in a specific orientation or position. Therefore, such terms should not be understood as limitations to the present application.

In addition, the terms “first” and “second” are used merely for description, rather than indicating or implying any relative importance, or indicating or implying the number of the mentioned technical feature. Consequently, the feature defined by the “first” and “second” may indicate or imply including one or more such feature. In the description of the present application, “a plurality of” means two or more, unless it is otherwise defined clearly and specifically.

In the present application, the terms “mount”, “interconnect”, “connect”, “fix” and the like should be understood in a broad sense, unless it is otherwise specified and defined clearly. For example, they may be fixed connection, or may be detachable connection, or may be integrated structure; they may be mechanical connection, or may be electrical connection; they may be direct connection, or may be indirect connection via a middle medium; they may be inside communication between two elements or interaction relation between two elements. For a person skilled in the art, the specific meanings of the above-mentioned terms in the present application may be understood based on specific situations.

In the present application, the definition of the first feature “above” or “below” the second feature may mean that the first and second features are in direct contact with each other, or the first and second features are in indirect contact via a middle medium, unless it is otherwise specified and defined clearly. Moreover, the definition of the first feature “on” or “above” the second feature may mean that the first feature is right above or obliquely above the second feature, or only mean that the first feature is higher in height than the second feature. The definition of the first feature “below” or “beneath” the second feature may mean that the first feature is right below or obliquely below the second feature, or merely mean that the first feature is lower in height than the second feature.

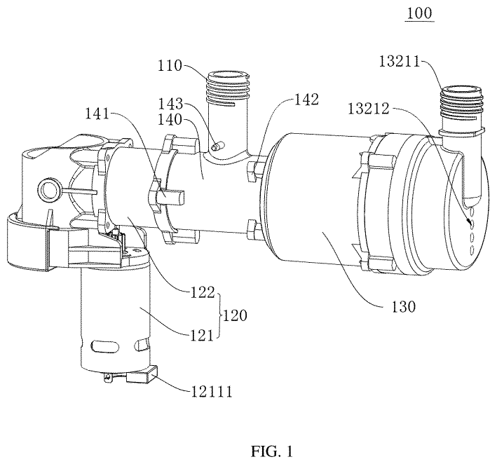

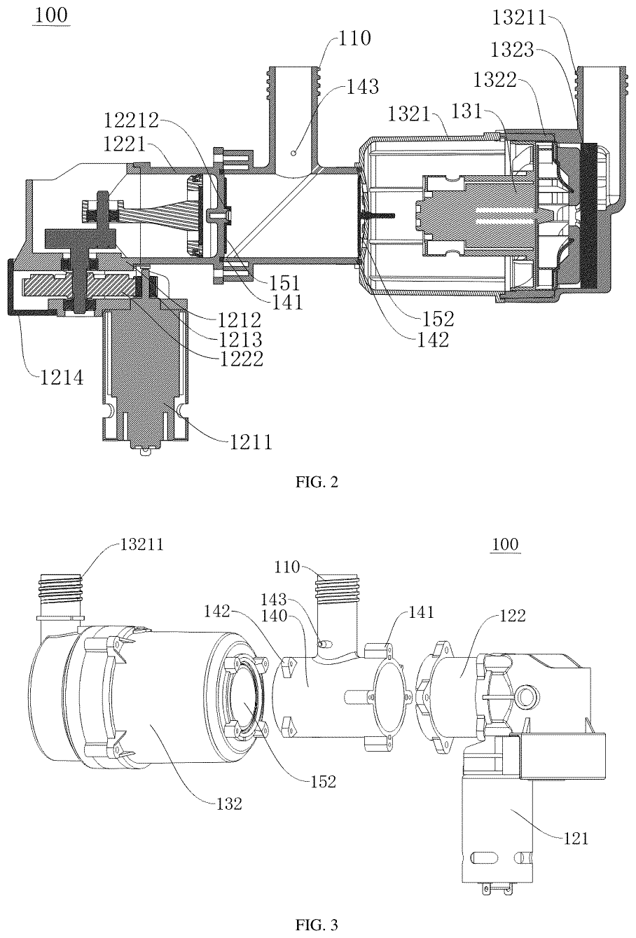

As shown in FIG. 1 and FIG. 2, in an embodiment of the present application, an inflation pump 100 is provided, and is mainly used for an inflation apparatus 1000. The inflation pump 100 includes a first mounting part 110, a first inflation apparatus 120 and a second inflation apparatus 130.

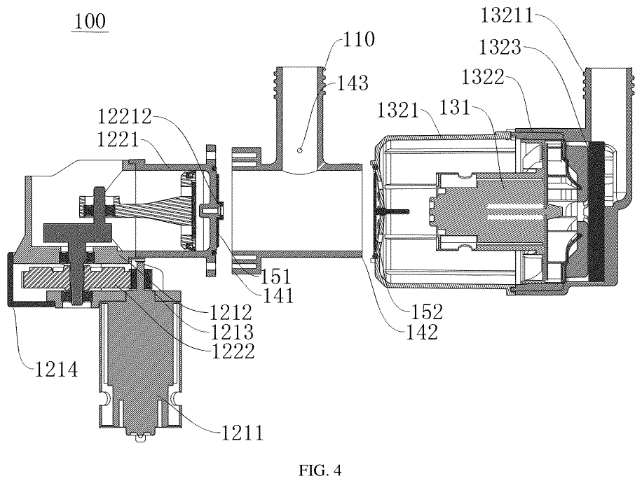

Referring to FIG. 3 and FIG. 4 together, the first mounting part 110 is used for connecting an apparatus to be inflated. The first inflation apparatus 120 is used for inflating the apparatus to be inflated. The first inflation apparatus 120 includes a first driving assembly 121 and a first inflation assembly 122. The first driving assembly 121 is used for supplying power to the first inflation assembly 122, and the first inflation assembly 122 is used for providing a first air flow to the first mounting part 110.

The second inflation apparatus 130 is used for inflating the apparatus to be inflated. The second inflation apparatus 130 includes a second driving assembly 131 and a second inflation assembly 132. The second driving assembly 131 is used for supplying power to the second inflation assembly 132, and the second inflation assembly 132 is connected to the first inflation assembly 122 and is used for providing a second air flow to the first mounting part 110.

According to the inflation pump 100 provided by an embodiment of the present application, by providing the first driving assembly 121 for supplying power to the first inflation assembly 122, the first inflation assembly 122, driven by the first driving assembly 121, provides the first air flow to the first mounting part 110, to make the first mounting part 110 inflate the apparatus to be inflated. By providing the second driving assembly 131 for supplying power to the second inflation assembly 132 which is connected to the first inflation assembly 122, the second inflation assembly 132, driven by the second driving assembly 131, provides the second air flow to the first mounting part 110, to make the first mounting part 110 inflate the apparatus to be inflated. Compared with the inflation pump having the single cylinder structure in the conventional art, an inflation efficiency is effectively improved, so that an inflation speed is increased, and thus an inflation time is shortened, it is suitable for inflation of apparatuses with a relatively large size. Furthermore, the inflation pump 100 is high in inflation stability and has a longer service time than the inflation pump having the single cylinder structure. Therefore, the technical problems that the inflation pumps in the conventional technologies mostly have the single cylinder structure, which result in insufficient gas pressure, long inflation time and difficulty in inflating devices with a relatively large size.

Exemplarily, the first mounting part 110 may be an inflation port having an outer thread or a snap-fitting structure, and the apparatus to be inflated may be a paddle blade or a rubber boat. The first inflation assembly 122 may be formed by a cylinder body and a piston. The first driving assembly 121 may be formed by a rotation motor, a gear train and a transmission mechanism. The transmission mechanism may be a crank slider mechanism, a cam mechanism, a rack and pinion mechanism or an eccentric wheel mechanism, for driving the piston to reciprocate linearly. The second inflation assembly 132 may be formed by a housing and an inlet fan. The second driving assembly 131 may be a rotation motor.

As shown in FIG. 1 to FIG. 3, in an embodiment of the present application, optionally, the inflation pump 100 further includes a gas pipe 140 including a second mounting part 141 and a third mounting part 142. The first mounting part 110 is provided on the gas pipe 140, the first inflation assembly 122 is connected to the second mounting part 141, and the second inflation assembly 132 is connected to the third mounting part 142. In the present embodiment, the first mounting part 110 is provided on the gas pipe 140. By connecting the first inflation assembly 122 to the second mounting part 141 of the gas pipe 140, when it is needed for the first air flow to enter the apparatus to be inflated, the first inflation assembly 122 is driven by the first driving assembly 121 to generate the first air flow which flows in sequence through the second mounting part 141 and the first mounting part 110, and then enters the apparatus to be inflated. By connecting the second inflation assembly 132 to the third mounting part 142 of the gas pipe 140, when it is needed for the second air flow to enter the apparatus to be inflated, the second inflation assembly 132 is driven by the second driving assembly 131 to generate the second air flow which flows in sequence through the third mounting part 142 and the first mounting part 110, and then enters the apparatus to be inflated.

Exemplarily, the second mounting part 141 and the first mounting part 110 are coaxially arranged (not shown in the figure) such that the second mounting part 141 and the third mounting part 142 are not coaxially arranged, which facilitates reducing a whole length of the inflation pump 100, and thus the inflation pump 100 has a smaller volume for being conveniently carried.

As shown in FIG. 1 and FIG. 2, the second mounting part 141 and the third mounting part 142 are coaxially arranged such that the second mounting part 141 and the first mounting part 110 are not coaxially arranged, which facilitate reducing a whole width of the inflation pump 100, and thus the inflation pump 100 has a smaller volume for being conveniently carried.

In an embodiment of the present application, optionally, in a unit time, a volume of gas provided by the first inflation apparatus 120 to the first mounting part 110 is less than a volume of gas provided by the second inflation apparatus 130 to the first mounting part 110.

In an embodiment of the present application, optionally, a gas pressure of gas provided by the first inflation apparatus 120 to the first mounting part 110 is higher than a gas pressure of gas provided by the second inflation apparatus 130 to the first mounting part 110. That is, when the efficiency of inflating the apparatus to be inflated by the second inflation apparatus 130 is low, the first inflation apparatus 120 is adopted for inflating the apparatus to be inflated. In this way, the inflation pump 100 as provided in the present application may selectively provide the first air flow or the second air flow according a gas pressure required by the apparatus to be inflated.

As shown in FIG. 1, FIG. 2 and FIG. 9, in an embodiment of the present application, optionally, the inflation pump further includes a gas pressure detection apparatus 1431 and a fourth mounting part 143. The fourth mounting part 143 is provided at the inflation pump 100 close to the first mounting part 110, and the gas pressure detection apparatus 1431 is provided at the fourth mounting part 143 and is used for detecting a gas pressure of the apparatus to be inflated. In the present embodiment, by providing the fourth mounting part 143 at the inflation pump 100 close to the first mounting part 110 and mounting the gas pressure detection apparatus 1431 on the fourth mounting part 143, the function of detecting the gas pressure of the apparatus to be inflated may be achieved. In this way, when the apparatus to be inflated is inflated to a preset pressure value, the controller 200 is capable of controlling the first driving assembly 121 and/or the second driving assembly 131 to stop rotating according to a signal feedback from the gas pressure detection apparatus 1431 to achieve the function that the inflation pump 100 is controlled to stop inflating the apparatus to be inflated.

Exemplarily, the gas pressure detection apparatus 1431 may include a pressure detection pipeline and a pressure sensor. The pressure sensor is provided on the controller 200. The pressure detection pipeline is connected to the pressure sensor and the fourth mounting part 143 separately.

In some other embodiments, the gas pressure detection apparatus 1431 may include a pressure detection pipeline and a pressure sensor assembly. The pressure detection pipeline is connected to the pressure sensor assembly and the fourth mounting part 143 separately. Herein, the pressure sensor assembly includes a housing, a circuit board and a pressure sensor. The housing is provided in the outer housing 400, the circuit board is provided in the housing, the pressure sensor is provided on the circuit board, and the circuit board is electrically connected to the controller 200.

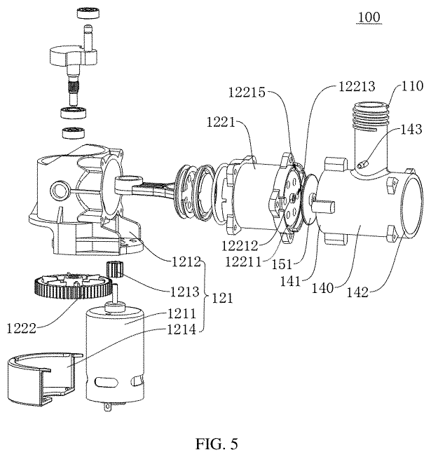

As shown in FIG. 1, FIG. 2 and FIG. 5, in the above-mentioned embodiment(s) of the present application, optionally, a first check valve 151 for unidirectionally passing through the first air flow is provided between the first inflation assembly 122 and the second mounting part 141. In the present embodiment, the first check valve 151 serves to unidirectionally pass through the first air flow such that the first inflation assembly 122 is driven by the first driving assembly 121 to generate the first air flow which flows in sequence through the first check valve 151, the second mounting part 141 and the first mounting part 110, and then enters into the apparatus to be inflated, and also prevent gas in the second inflation assembly 132 or the apparatus to be inflated from entering the first inflation assembly 122 in an opposite direction.

As shown in FIG. 1, FIG. 2 and FIG. 5, in the above-mentioned embodiments of the present application, optionally, the first check valve 151 is provided on the first inflation assembly 122. Consequently, stable mounting for the first check valve 151 is achieved.

As shown in FIG. 1, FIG. 2 and FIG. 5, in the above-mentioned embodiments of the present application, optionally, the first inflation assembly 122 includes a first cylinder 1221 having a first surface 12211. A fifth mounting part 12212 for mounting the first check valve 151 is provided at a center of the first surface 12211, and the first surface 12211 is provided with a plurality of first vent holes 12213. In the present embodiment, by providing the fifth mounting part 12212 at the center of the first surface 12211 of the first cylinder 1221, the function of stable mounting for the first check valve 151 can be achieved. By providing the plurality of first vent holes 12213 at the first surface 12211, the first inflation assembly 122 is driven by first driving assembly 121 to produce the first air flow flowing in sequence through the first vent holes 12213, the first check valve 151, the second mounting part 141 and the first mounting part 110, and then into the apparatus to be inflated.

As shown in FIG. 1, FIG. 2 and FIG. 5, in the above-mentioned embodiments of the present application, optionally, the first inflation assembly 122 includes a first cylinder 1221 having a first through hole 12215. A sixth mounting part for mounting the first check valve 151 is provided in the first through hole 12215 close to the second mounting part 141. In the present embodiment, by providing the sixth mounting part in the first through hole 12215 of the first cylinder 1221 close to the second mounting part 141, the stable mounting of the first check valve 151 is achieved.

In the above-mentioned embodiments of the present application, optionally, the first check valve 151 is provided on the gas pipe 140 (not shown in the figure). Consequently, the stable mounting of the first check valve 151 is achieved.

In the above embodiments of the present application, optionally, the gas pipe 140 has a second surface. A seventh mounting part for mounting the first check valve 151 is provided at a center of the second surface. The second surface is provided with a plurality of second vent holes (not shown in the figures). In the present embodiment, by providing the seventh mounting part at the center of the second surface of the gas pipe 140, the stable mounting of the first check valve 151 is achieved. By providing the plurality of second vent holes at the second surface, the first inflation assembly 122 is driven by the first driving assembly 121 to generate the first air flow which flows in sequence through the first check valve 151, the second vent holes and the first mounting part 110, and then enters the apparatus to be inflated.

In the above-mentioned embodiments of the present application, optionally, an eighth mounting part for mounting the first check valve 151 (not shown in the figure) is provided on an inner wall of the gas pipe 140 close to the first inflation assembly 122. In the present embodiment, by providing the eighth mounting part on the inner wall of the gas pipe 140 close to the first inflation assembly 122, the stable mounting of the first check valve 151 is achieved.

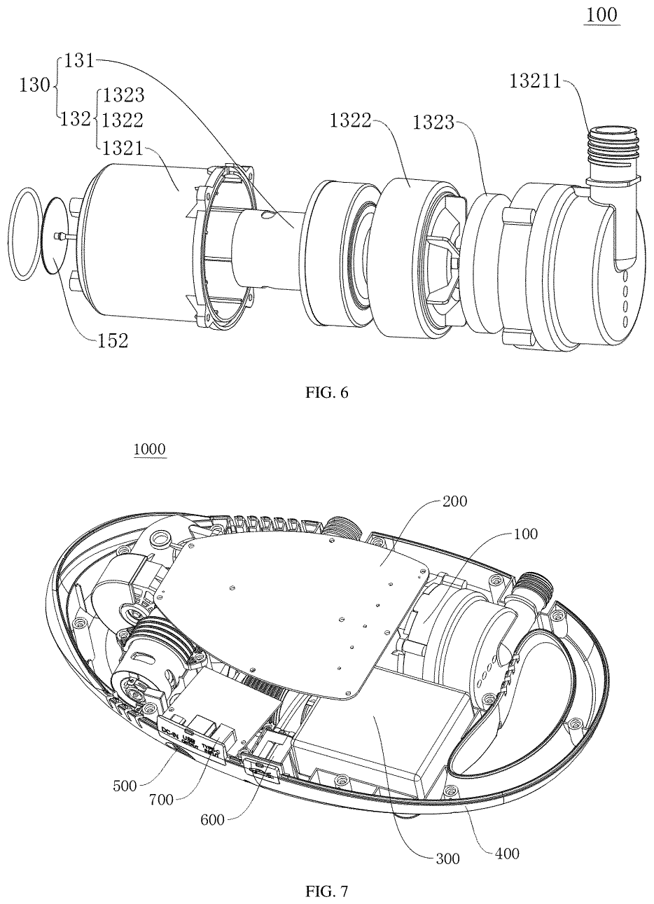

As shown in FIG. 1, FIG. 2, FIG. 3 and FIG. 6, in the above-mentioned embodiments of the present application, optionally, a second check valve 152 for unidirectionally passing through the second air flow is provided between the second inflation assembly 132 and the third mounting part 142. In the present embodiment, the second check valve 152 serves to unidirectionally pass through the second air flow to make the second inflation assembly 132 be driven by the second driving assembly 131 to generate the second air flow which flows in sequence through the second check valve 152, the third mounting part 142 and the first mounting part 110, and then enters into the apparatus to be inflated, and also prevent gas in the first inflation assembly 122 or the apparatus to be inflated from entering the second inflation assembly 132 in the opposite direction.

In an embodiment of the present application, optionally, a third check valve (not shown in the figure), for unidirectionally passing through the first air flow or the second air flow to inflate the apparatus to be inflated, is provided at the first mounting part 110 of the inflation pump 100. In the present embodiment, the third check valve functions to unidirectionally pass through the first air flow and/or the second air flow to make the first air flow and/or the second air flow flow in sequence through the third check valve and the first mounting part 110, and then enter the apparatus to be inflated, and also prevent gas in the apparatus to be inflated from entering the gas pipe 140 in the opposite direction.

As shown in FIG. 1, in an embodiment of the present application, optionally, the first driving assembly 121 includes a first motor 1211 electrically connected to a capacitor 12111. Consequently, the first motor 1211 is electrically connected to the capacitor 12111 to prevent rotation of the first motor 1211 from interfering normal operations of other elements, so that stability of the first motor 1211 is improved. Exemplarily, the first motor 1211 is provided, at its end away from the first inflation assembly 122, with one capacitor 12111. That is, the one capacitor 12111 is directly connected between positive and negative terminals of the first motor 1211.

As shown in FIG. 1, FIG. 2 and FIG. 5, in an embodiment of the present application, optionally, the first driving assembly 121 includes a first motor 1211 and a first support 1212 for mounting the first motor 1211, and the first inflation assembly 122 includes a first cylinder 1221 connected to the first support 1212. In the present embodiment, by mounting the first motor 1211 on the first support 1212, the stable mounting of the first motor 1211 is achieved. By connecting the first support 1212 to the first cylinder 1221, the stable mounting of the first cylinder 1221 is achieved.

As shown in FIG. 1, FIG. 2 and FIG. 5, in an embodiment of the present application, optionally, the first driving assembly 121 includes a first motor 1211, a first motor gear 1213, a first support 1212. The first inflation assembly 122 includes a first big gear 1222 which is rotatably connected to the first support 1212 and is engaged with the first motor gear 1213. In some embodiments, the first driving assembly 121 further includes a first protection cover 1214, and the first protection cover 1214 is connected to the first support 1212 and is used for protecting the first big gear 1222.

In the above-mentioned embodiment, the first big gear 1222 is rotatably provided in the first support 1212 and is engaged with the first motor gear 1213, the first motor gear 1213 is driven by the first motor 1211 to rotate to drive the first big gear 1222 to rotate, so that a crank connecting rod mechanism is driven to move, and thus the piston is driven to reciprocate linearly in the first cylinder 1221 to achieve inflation function of the first inflation apparatus 120. The first protection cover 1214 serves to protect the first big gear 1222 to prevent the first big gear 1222 from contacting with an external mechanism and affecting rotation of the first big gear 1222, to make the first big gear 1222 be stably rotated in the first support 1212.

In an embodiment of the present application, optionally, the first inflation assembly 122 includes a first cylinder 1221 and a first gas outlet pipe (not shown in the figures) disposed on the first cylinder 1221, and preferably, the first gas outlet pipe is integrally formed with the first cylinder 1221. The first mounting part 110 is provided on the first gas outlet pipe, and the first gas outlet pipe is connected to the second inflation assembly 132. Thus, the first inflation assembly 122 is driven by the first driving assembly 121 to generate the first air flow which flows in sequence through the first gas outlet pipe and the first mounting part 110, and then enters the apparatus to be inflated. Meanwhile, the second inflation assembly 132 is driven by the second driving assembly 131 to generate the second air flow which flows in sequence through the first gas outlet pipe and the first mounting part 110, and then enters the apparatus to be inflated. The first cylinder 1221 and the first gas outlet pipe are integrally formed, so that steps of mounting between the first cylinder 1221 and the first gas outlet pipe is reduced, and thus entire mounting efficiency is effectively improved.

In an embodiment of the present application, optionally, the second inflation assembly 132 includes a blower housing 1321 and a second gas outlet pipe (not shown in the figures) disposed on the blower housing 1321, and preferably, the second gas outlet pipe is integrally formed with the blower housing 1321. The first mounting part 110 is provided on the second gas outlet pipe, and the second gas outlet pipe is connected to the first inflation assembly 122. Consequently, the second inflation assembly 132 is driven by the second driving assembly 131 to generate the second air flow which flows in sequence through the second gas outlet pipe and the first mounting part 110, and then enters the apparatus to be inflated. Meanwhile, the first inflation assembly 122 is driven by the first driving assembly 121 to generate the first air flow which flows in sequence through the second gas outlet pipe and the first mounting part 110 and then enters the apparatus to be inflated. The blower housing 1321 and the second gas outlet pipe are integrally formed, so that the steps of mounting between the blower housing 1321 and the second gas outlet pipe is reduced, and thus the entire mounting efficiency is effectively improved.

As shown in FIG. 1, FIG. 2, FIG. 3 and FIG. 6, in an embodiment of the present application, optionally, the second inflation assembly 132 includes a blower housing 1321. A ninth mounting part 13211, for gas intake or connecting to an apparatus to be deflated, is provided at an end of the blower housing 1321 away from the first mounting part 110. In the present embodiment, by providing the ninth mounting part 13211 at the end of the blower housing 1321 away from the first mounting part 110, the outside air is capable of entering the second inflation assembly 132 via the ninth mounting part 13211 under the action of the second driving assembly 131, so that the second air flow is formed and is inflated into the apparatus to be inflated through the first mounting part 110.

In addition, the ninth mounting part 13211 is also capable of being connected to an apparatus to be deflated to make gas in the apparatus to be deflated enter the second inflation assembly 132 via the ninth mounting part 13211 under the action of the second driving assembly 131, so that the second air flow is formed and is discharged to external environment through the first mounting part 110.

As shown in FIG. 1, FIG. 2, FIG. 3 and FIG. 6, in the above-mentioned embodiments of the present application, optionally, the second inflation assembly 132 further includes a blower support 1322 provided in the blower housing 1321. A protection member 1323 for filtering gas from the ninth mounting part 13211 is provided between the blower housing 1321 and an end of the blower support 1322 close to the ninth mounting part 13211. In the present embodiment, by providing the protection member 1323 between the blower housing 1321 and the end of the blower support 1322 close to the ninth mounting part 13211, the gas from the ninth mounting part 13211 is filtered, so that a function of filtering is achieved, and thus impurities in the gas is prevented from entering the second inflation apparatus 130 or the apparatus to be inflated. Exemplarily, the protection member 1323 may be made of a material of sponge to make the gas pass through the protection member 1323, while the impurities, such as dust and the like, in the gas are blocked and filtered by the protection member 1323.

As shown in FIG. 1 and FIG. 2, in the above-mentioned embodiments of the present application, optionally, at least one second through hole 13212 is provided at an end of the blower housing 1321 away from the first mounting part 110, for preventing the blower from damage due to overheating. In the present embodiment, by providing the at least one second through hole 13212 at the end of the blower housing 1321 away from the first mounting part 110, a function of ventilation is enabled when the ninth mounting part 13211 is connected to the apparatus to be deflated to deflate the apparatus to be deflated. In this way, after deflation of the apparatus to be deflated is completed, when the second driving assembly 131 continues working, the external gas is capable of entering the second inflation assembly 132 via the second through hole 13212, so that the second air flow is formed and is discharged to the external environment through the first mounting part 110, and thus the second driving assembly 131 is prevented from damage due to overheating of operation because a user forgets to turn off the second driving assembly 131 after deflation of the apparatus to be deflated is completed.

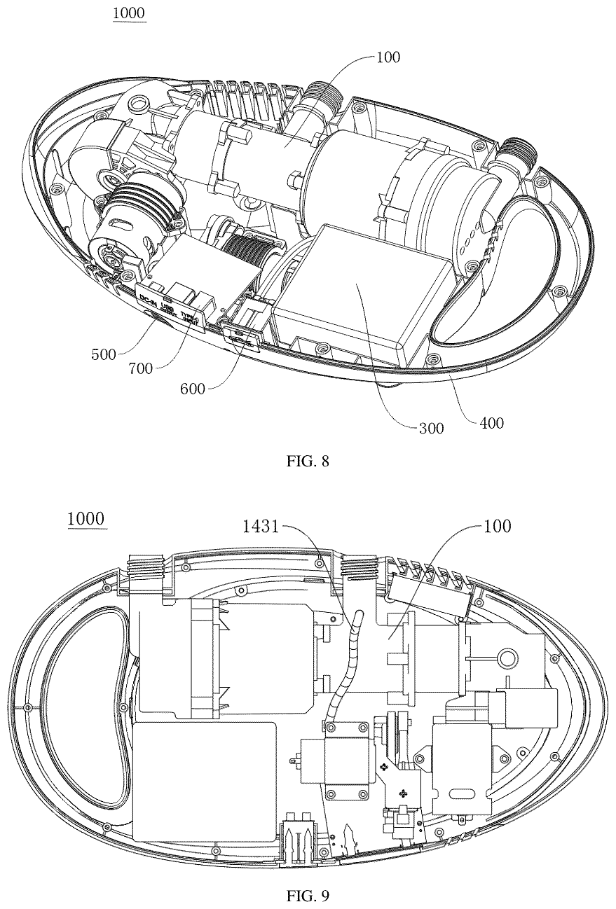

As shown in FIG. 7 and FIG. 8, in the embodiments of the present application, an inflation device 1000 is further provided. The inflation device 1000 includes the inflation pump 100 in any embodiment as described above, a controller 200, a power source 300 and an outer housing 400.

Herein, the controller 200 is electrically connected to the first driving assembly 121 and the second driving assembly 131. The power source 300 for supplying power is electrically connected to the controller 200 and the inflation pump 100. The inflation pump 100, the controller 200 and the power source 300 are provided in the outer housing 400.

In the inflation device 1000 as provided in the embodiments of the present application, by electrically connecting the controller 200 to the first driving assembly 121 and the second driving assembly 131, the first driving assembly 121 and the second driving assembly 131 are controlled to be started or stopped, so that the function of starting or stopping inflation of the first inflation apparatus 120 is achieved, and the functions of starting or stopping inflation, or starting or stopping deflation of the second inflation apparatus 130 are achieved. By providing that the power source 300 is electrically connected to the controller 200 and the inflation pump 100, the function of supplying power to the controller 200 and the inflation pump 100 is achieved by the power source 300. By providing the inflation pump 100, the controller 200 and the power source 300 in the outer housing 400, the functions of mounting and protection for the inflation pump 100, the controller 200 and the power source 300 are achieved.

Exemplarily, the controller 200 may be a printed circuit board or a flexible circuit board. The power source 300 may be a rechargeable battery.

As shown in FIG. 7 and FIG. 8, in the above-mentioned embodiments of the present application, optionally, the inflation apparatus 1000 further includes a third inflation apparatus 500 provided in the outer housing 400. The third inflation apparatus 500 includes a third driving assembly 510 and a third inflation assembly 520. The third driving assembly 510 is connected to the third inflation assembly 520 and is used for supplying power to the third inflation assembly 520, and an end of the third inflation assembly 520 away from the third driving assembly 510 is used for connecting the apparatus to be inflated. The third driving assembly 510 is electrically connected to the power source 300 and the controller 200.

In the present embodiment, by providing the third driving assembly 510 for supplying power to the third inflation assembly 520, the third inflation assembly 520 is driven by the third driving assembly 510 to provide a third air flow at the end of the third inflation assembly 520 away from the third driving assembly 510, so that the apparatus to be inflated is inflated through the end of the third inflation assembly 520 away from the third driving assembly 510. In an example, the apparatus to be inflated may be a vehicle tire. By electrically connecting the third driving assembly 510 to the power source 300 and the controller 200, the third driving assembly 510 is controlled to be started or stopped, so that the function of starting or stopping inflation of the third inflation apparatus 500 is achieved.

The third inflation assembly 520 may be formed by a cylinder and a piston. The third driving assembly 510 may be formed by a rotation motor, a gear train and a transmission mechanism. The transmission mechanism may be a crank slider mechanism, a cam mechanism, a rack and pinion mechanism or an eccentric wheel mechanism, for driving the piston to reciprocate linearly.

In the above-mentioned embodiments of the present application, optionally, in a unit time, a volume of gas provided by the third inflation apparatus 500 to the apparatus to be inflated is less than a volume of gas provided by the first inflation apparatus 120 to the apparatus to be inflated.

In the above embodiments of the present application, optionally, c provided by the third inflation apparatus 500 to the apparatus to be inflated is higher than a volume of gas provided by the first inflation apparatus 120 to the apparatus to be inflated, such that the third inflation apparatus 500 is capable of inflating a vehicle tire with a relatively high tire pressure, and the first inflation apparatus 120 is capable of inflating a paddle blade or a rubber boat with a relatively low gas pressure.

As shown in FIG. 7 and FIG. 8, in the above-mentioned embodiments of the present application, optionally, the inflation device 1000 further includes a pair of output terminal 600. The output terminals 600 are electrically connected to the power source 300 and are used for outputting a current for starting a vehicle engine. In the present embodiment, by electrically connecting the power source 300 to the output terminal 600, to make the output terminal 600 output the current for starting the vehicle engine, so that a function of emergency starting for the vehicle by the inflation device 1000 is achieved.

As shown in FIG. 7 and FIG. 8, in the above-mentioned embodiments of the present application, optionally, the inflation device 1000 further includes at least one output port 700. The output port 700 is electrically connected to the power source 300 and is used for supplying power to an external device. In the present embodiment, by electrically connecting the power source 300 to the output port 700, the output port 700 is capable of outputting a current required for an external apparatus (such as a mobile phone).

In the description of the present specification, the description referring to the terms of “an embodiment”, “some embodiments”, “example”, “specific example”, or “some examples” or the like means that the specific features, structures, materials, or characteristics as described in combination with the embodiments or examples are included in at least one embodiment or example of the present application. In the present specification, it is not necessary for the schematic expressions of the above terms to be used for the same embodiment or example. Moreover, the described specific features, structures, materials, or characteristics may be combined in any one or more embodiments or examples in an appropriate manner. In addition, those skilled in the art may combine the different embodiments or examples in the present specification or the features thereof, unless they are contradictory.

Though the embodiments of the present application have been illustrated and described as above, it is understandable that the above-mentioned embodiments are exemplary, and can not be understood as limitations to the present application. A person skilled in the art may make changes, modifications, substitutions and variations to the above embodiments within the scope of the present application.

1. An inflation pump, comprising:
a first mounting part for connecting an apparatus to be inflated;
a first inflation apparatus, wherein the first inflation apparatus comprises a first driving assembly and a first inflation assembly, the first driving assembly is configured to supply power to the first inflation assembly, and the first inflation assembly is configured to provide a first air flow to the first mounting part to inflate the apparatus to be inflated; and
a second inflation apparatus, wherein the second inflation apparatus comprises a second driving assembly and a second inflation assembly, the second driving assembly is configured to supply power to the second inflation assembly, and the second inflation assembly is connected to the first inflation assembly and is configured to provide a second air flow to the first mounting part to inflate the apparatus to be inflated; and
a second mounting part and a third mounting part being coaxially arranged, the first inflation assembly being connected to the second mounting part, and the second inflation assembly being connected to the third mounting part, wherein
the first inflation assembly comprises a first cylinder, the second inflating assembly comprises a blower housing, the first cylinder is coaxially arranged with the blower housing, and the first mounting part is not coaxial with the blower housing and the first cylinder.

2. The inflation pump according to claim 1, further comprising a gas pipe comprising the second mounting part and the third mounting part, wherein the first mounting part is provided on the gas pipe, the first inflation assembly is connected to the second mounting part, and the second inflation assembly is connected to the third mounting part.

3-4. (canceled)

5. The inflation pump according to claim 1, wherein in a unit time, a volume of gas provided by the first inflation apparatus to the first mounting part is less than a volume of gas provided by the second inflation apparatus to the first mounting part.

6. The inflation pump according to claim 1, further comprising a gas pressure detection apparatus and a fourth mounting part, wherein the fourth mounting part is provided, close to the first mounting part, at the inflation pump, and the gas pressure detection apparatus is provided at the fourth mounting part and is configured to detect a gas pressure of the apparatus to be inflated.

7. The inflation pump according to claim 2, wherein a first check valve for unidirectionally passing through the first air flow is provided between the first inflation assembly and the second mounting part; and the first check valve is provided on the first inflation assembly.

8. (canceled)

9. The inflation pump according to claim 2, wherein a second check valve for unidirectionally passing through the second air flow is provided between the second inflation assembly and the third mounting part.

10. The inflation pump according to claim 1, wherein a third check valve, for unidirectionally passing through the first air flow or the second air flow to inflate the apparatus to be inflated, is provided at the first mounting part of the inflation pump.

11. The inflation pump according to claim 1, wherein the first driving assembly comprises a first motor electrically connected with a capacitor.

12. The inflation pump according to claim 1, wherein the first driving assembly comprises a first motor and a first support for mounting the first motor, and the first inflation assembly comprises a first cylinder connected to the first support.

13. The inflation pump according to claim 1, wherein the first inflation assembly further comprises a first gas outlet pipe disposed on the first cylinder, the first mounting part is provided on the first gas outlet pipe, and the first gas outlet pipe is connected to the second inflation assembly.

14. The inflation pump according to claim 1, wherein the second inflation assembly further comprises a second gas outlet pipe disposed on the blower housing, the first mounting part is provided on the second gas outlet pipe, and the second gas outlet pipe is connected to the first inflation assembly.

15. The inflation pump according to claim 1, wherein a ninth mounting part, for gas intake or connection with an apparatus to be deflated, is provided at an end of the blower housing away from the first mounting part.

16. The inflation pump according to claim 15, wherein at least one second through hole is provided at the end of the blower housing away from the first mounting part, for preventing the blower housing from damage due to overheating.

17. An inflation apparatus, comprising:
the inflation pump according to claim 1;
a controller, electrically connected to the first driving assembly and the second driving assembly;
a power source for supplying power, electrically connected to the controller and the inflation pump; and
an outer housing in which the inflation pump, the controller and the power source are provided.

18. The inflation apparatus according to claim 17, further comprising:
a third inflation apparatus provided in the outer housing, wherein
the third inflation apparatus comprises a third driving assembly and a third inflation assembly, the third driving assembly is connected to the third inflation assembly and is used for supplying power to the third inflation assembly, and an end of the third inflation assembly away from the third driving assembly is used for connecting the apparatus to be inflated; and
the third driving assembly is electrically connected to the power source and the controller.

19. The inflation apparatus according to claim 18, wherein in a unit time, a volume of gas provided by the third inflation apparatus to the apparatus to be inflated is less than a volume of gas provided by the second inflation apparatus to the apparatus to be inflated.

20. The inflation apparatus according to claim 17, further comprising a pair of output terminals, wherein the pair of output terminals are electrically connected to the power source and are configured to output a current for starting an engine of a vehicle.

21. The inflation pump according to claim 7, wherein the first cylinder has a first surface, a center of the first surface is provided with a fifth mounting part for mounting the first check valve, and the first surface is provided with a plurality of first vent holes.

22. The inflation pump according to claim 12, wherein the first driving assembly further comprises a first motor gear and a first protection cover, the first inflation assembly further comprises a first big gear which is rotatably connected to the first support and is engaged with the first motor gear, and the first protection cover is connected to the first support and is used for protecting the first big gear.

23. The inflation pump according to claim 16, wherein the second inflation assembly further includes a blower support provided in the blower housing, a protection member for filtering gas from the ninth mounting part is provided between the blower housing and an end of the blower support close to the ninth mounting part.
